(19) United States
(12) Patent Application Publication
(10) Pub. No.: US 2007/0174005 A1
(43) Pub. Date: Jul. 26, 2007

(54) Topographic map display device for aircraft

(76) Inventors: Elias Bitar, Toulouse (FR); Nicolas Marty, Castelginest (FR)

Correspondence Address: LOWE HAUPTMAN & BERNER, LLP, 1700 DIAGONAL ROAD, SUITE 300, ALEXANDRIA, VA, 22314, US

(21) Appl. No.: 10/590,083

(22) PCT Filed: Feb. 8, 2005
(86) PCT No.: PCT/EP05/50536

§ 371 Date: Aug. 21, 2006

(30) Foreign Application Priority Data
Mar. 12, 2004 (FR) 04 02601

(51) Int. Cl. G01C 23/00

(52) U.S. Cl. 701/211; 701/3; 701/301

(57) ABSTRACT

This display device displays a 2D topographic map corresponding to terrain sections with mainly horizontal profile referenced with respect to an absolute altitude that is greater than that of the highest surrounding relief, which is termed the safety altitude MSA_{EDGE} and which is deduced from the minimum safety altitudes of the points of the zone of largest probability of presence of the aircraft in the course of an emergency descent.

### BACKGROUND OF THE INVENTION

1. Field of the Invention

The present invention pertains to topographic map display onboard aircraft, in particular onboard aircraft equipped with ground proximity warning systems displaying, on the instrument panel, visual alarms pinpointing on a map the reliefs and obstacles on the ground considered to be threatening.

2. Description of the Related Art

It has long been known to display on the instrument panel of an aircraft a topographic map of the region overflown by utilizing the current position provided by the navigation instruments of the aircraft to extract from a topographic database a 2D map of the relief of the region overflown plotted on the basis of the level lines. However, such a map has a very different appearance from that of visual alarms showing the threatening reliefs and obstacles on the ground and the switch from one to the other at the moment of the appearance or of the disappearance of a visual alarm may engender poor interpretations on the part of the crew.

Ground proximity warning systems are aimed at preventing aeronautical accidents in which an aircraft that is still maneuverable crashes to the ground, which accidents are known in the literature by the acronym CFIT standing for “Controlled Flight Into Terrain”.

The first ground proximity warning systems known by the name GPWS (the acronym standing for “Ground Proximity Warning System”) did not pinpoint on a map the threatening reliefs or obstacles on the ground since they took account only of the flight conditions of the aircraft. As they posed a problem of adjustment of their sensitivity, a compromise having to be sought between timely triggering with each true risk of collision with the ground and a minimum of false alarms, it was rapidly sought to refine them by adding to the information taken into account, navigation data and relief maps extracted from airborne topographic databases carried onboard or accessible from the aircraft in flight. Thus the appearance was seen of ground proximity warning systems called TAWS (the acronym standing for “Terrain Awareness Warning System”) fulfilling, in addition to the customary GPWS functions, an additional function of predictive alert of risks of collision with the relief or with obstacles on the ground consisting in alerting the crew of the aircraft when the short-term foreseeable trajectory of the aircraft may encounter the ground or an obstacle on the ground.

These ground proximity warning systems of TAWS type monitor the penetration of the relief or of an obstacle on the ground in one or more protection volumes related to the aircraft and extending in front of and below the aircraft in such a way as to contain the majority of the break-off trajectories within the range of the aircraft, vis-à-vis a possible relief or obstacle on the ground placed on its short-term foreseeable trajectory and generate, with each detection of the intrusion of the relief or of an obstacle on the ground into these protection volumes, audible and visual alarms and alerts. Among the visual alarms, one of them consists of a display on a screen of the instrument panel, of a map of the region overflown showing, in a finer or coarser manner, the contours of the parts of the relief or of obstacles on the ground considered to be threatening.

Customarily, ground proximity warning systems of TAWS type use at least two projection envelopes related to the aircraft, an alarm protection envelope corresponding to the very short-term alarms requiring an immediate avoidance maneuver on the part of the crew and a larger alert protection envelope, encompassing the alarm protection envelope, corresponding to the medium-term alerts intended to attract the attention of the crew to the need to envisage an avoidance maneuver. For the displaying of the visual alarms and alerts pinpointing on a map the threatening reliefs and obstacles on the ground, the warning systems of TAWS type use the current position of the aircraft as derived from the navigation information delivered by the onboard equipment so as to extract, from a topographic database, a map of the region overflown by the aircraft, and place on this map the contours of the reliefs and obstacles on the ground which penetrate into one at least of the aircraft's protection volumes.

The map of visual alarms and alerts is generally a 2D map showing the contours of the threatening reliefs and obstacles on the ground of the region overflown, which are represented with various aspects as a function of the significance of the threat. Generally, the reliefs or obstacles on the ground that intercept the alarm protection envelope and may therefore cause a short-term ground collision, are represented with a red color, those that intercept the alert protection envelope with a somewhat less vibrant yellow color and the remainder of the map with a green color so as to approximate the meaning of three-color traffic lights: red signifying prohibition, yellow permission with precautions requiring attention, and green absence of danger. The 2D display of these threatening reliefs or obstacles on the ground may call upon the projection on the horizontal of a stack of terrain strata corresponding to sections of the relief ahead of the aircraft along horizontal profiles or approximating the lower profiles of the protection envelopes as described for example in French patent FR 2,773,609 corresponding to U.S. Pat. No. 6,088,654.

Customarily, a ground proximity warning system of TAWS type displays a map of risks of collision only when a risk of collision with the ground is possible, that is to say below a certain flight altitude, in general 2000 feet. Above, it does not display anything although a map of the relief of the region overflown would be useful to the crew of the aircraft in certain circumstances, for example should it be necessary to rapidly lose altitude following a depressurization.

This problem has already been seen and solved in part, in particular in the ground proximity warning system described in U.S. Pat. No. 6,292,721 which uses an alert protection envelope whose lower profile takes account of a significant descent rate of the aircraft and whose viewing screen displays,
below 2000 feet, a map of the risks of collision with the ground showing contours of terrain zones colored red corresponding to the reliefs or obstacles on the ground triggering the alarms and contours of terrain zones colored yellow corresponding to the reliefs or obstacles on the ground triggering alerts of risk of collision with the ground, superimposed on a map of the relief of the zone overflown by the aircraft formed from the projection on the horizontal of a stack of terrain strata corresponding to horizontal sections referenced with respect to the altitude of the aircraft and being distinguished by their patterns: a first stratum with a pattern with dense texture corresponding to a difference of altitude of 500 feet or less with respect to the aircraft, a second stratum with a pattern with averagely dense texture corresponding to a difference of altitude of 500 to 1000 feet with respect to the aircraft and a third stratum with a pattern with a not very dense texture corresponding to a difference of altitude of greater than 2000 feet with respect to the aircraft, and
above 2000 feet, a map of the relief of the zone overflown formed from the projection on the horizontal of a stack of terrain strata distinguished by their colors and corresponding to tiered horizontal sections between the altitude of the lowest point and that of the highest point of the terrain zone represented, the intermediate strata being able to have a color dependent on their relative altitude with respect to the aircraft.

With this type of display, with each crossing of the 2000 feet level by the aircraft, discontinuities of representation appear which are due to the change of the reference altitude of the terrain strata which, being relative since it is related to that of the aircraft, becomes absolute since it is related to the altitude of the point of the relief displayed which is highest or lowest. At the transition, the meaning of the colors changes switching from the distinction between the risk-free zones, the zones with a medium-term risk and the zones with a short-term risk, to the ranking by levels of the terrain strata represented, this possibly giving rise to confusion on the part of the members of the crew at the tricky moment at which an alarm or an alert of risk of ground collision occurs.

### SUMMARY OF THE INVENTION

The aim of the present invention is to remedy this defect by virtue of a 2D topographic map display by projection on the horizontal of a stack of terrain strata referenced with respect to an absolute altitude adapted to an aircraft with an assignment to strata, of colors or patterns compatible with that of a visual alarm of a ground proximity warning system pinpointing on a map the threatening reliefs and obstacles on the ground.

Its subject is a device for 2D topographic map display for aircraft, extracting from a topographic database a map formed from the projection on the horizontal of a stack of terrain strata of the region overflown, corresponding to terrain sections with mainly horizontal profile, referenced with respect to an absolute altitude that is greater than that of the highest surrounding relief, which absolute altitude is termed the safety altitude.

Advantageously, when the topographic map is extracted from a topographic database storing the altitudes of a mesh of points of a zone of the terrestrial surface enclosing the region overflown, the safety altitude is deduced from the minimum local safety altitudes assigned to the points of the mesh of the topographic database.

Advantageously, the safety altitude is deduced from the minimum local safety altitudes assigned to the points of the mesh of the topographic database belonging, in the region overflown, to a so-called emergency descent zone, related to the current position of the aircraft and containing probable trajectories predicted for an aircraft following a maximum imposed descent slope.

Advantageously, the value of the safety altitude is extracted from the distribution, as a function of their values, of the minimum local safety altitudes assigned to the points of the mesh of the topographic database belonging, in the region overflown, to an emergency descent zone, related to the current position of the aircraft and containing probable trajectories predicted for an aircraft following a maximum imposed descent slope, and corresponds to the maximum value of the minimum local safety altitudes appearing in this distribution after clipping of a certain percentage of the largest values of minimum local altitudes that it contains.

Advantageously, the terrain strata represented correspond to terrain sections along horizontal profiles.

Advantageously, when the aircraft is at an altitude greater than the safety altitude with respect to which the terrain strata represented are referenced, the terrain strata represented correspond to terrain sections along mainly horizontal elbowed profiles reducing, by vertical translation, to a broken line starting with a first straight line segment with negative slope going from the current position of the aircraft up to the level of the safety altitude and continuing as a second horizontal straight line segment.

Advantageously, when the terrain strata correspond to terrain sections along elbowed profiles in the form of a broken line with a first straight line segment with a negative slope angle extended by a second horizontal straight line segment, the negative slope angle of the first straight line segment is taken equal to the most negative slope angle from among the angle of the current slope followed by the aircraft, the maximum descent slope angle permitted for the aircraft and the arc tangent of the ratio between the ground speed of the aircraft and a maximum descent speed permitted for the aircraft.

Advantageously, when the aircraft is below the safety altitude with respect to which the terrain strata represented are referenced, the terrain strata represented correspond to horizontal sections.

Advantageously, the colors and/or textures associated with the levels of terrain strata in a map displayed by the cartographic display device correspond to the same risk scale as that associated with the colors and/or textures of a visual alarm map originating from a ground proximity warning system.

Advantageously, the colors associated with the terrain strata represented, situated below the altitude of the aircraft, belong to the green interval.

Advantageously, the colors associated with the terrain strata represented, situated at levels close to the current altitude of the aircraft, belong to the yellow interval.

Advantageously, the color associated with the terrain strata represented, situated above the altitude of the aircraft, is red.

Advantageously, when the aircraft is equipped with a ground proximity warning system producing visual alarm maps pinpointing threatening reliefs or obstacles on the ground, the colors and/or textures associated with the levels of terrain strata represented in a relief map displayed by the topographic map display device comply with the same risk scale as those of the visual alarm maps and the topographic map display comprises a superposition circuit superimposing the visual alarm maps on the map of the relief which appears as background around threatening reliefs and obstacles on the ground.

Advantageously, when the aircraft is equipped with a ground proximity warning system producing visual alert and alarm maps pinpointing threatening reliefs and obstacles on the ground and distinguishing them by different colors and/or textures as a function of the short- or medium-term character of the threat that they pose, the color and/or texture associated, in an alarm and alert map, with a relief or obstacle on the ground giving rise to a short-term threat are borrowed for a terrain stratum level represented situated at an altitude greater than that of the aircraft and the color and/or the texture associated with a relief or an obstacle on the ground giving rise to a medium-term threat are borrowed for a terrain stratum level represented situated at the altitude of the aircraft.

### BRIEF DESCRIPTION OF THE DRAWINGS

Other characteristics and advantages of the invention will emerge from the description hereinafter of an embodiment given by way of example. This description will be offered in conjunction with a drawing in which:

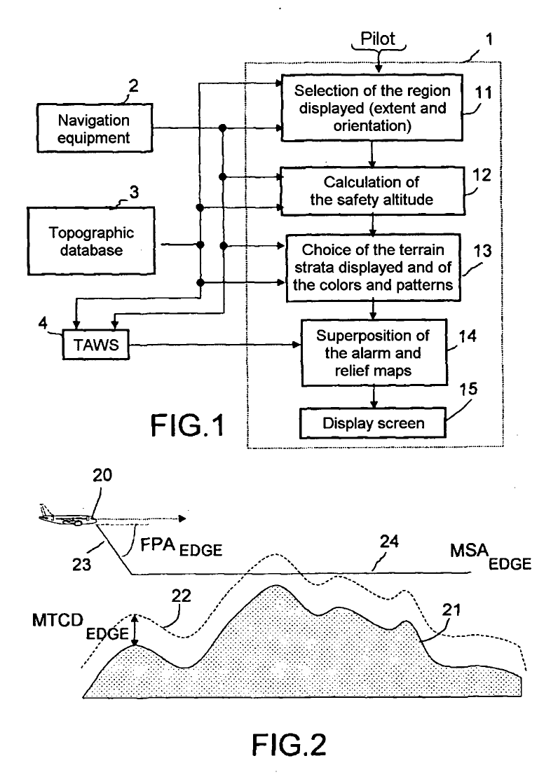

a FIG. 1 is a diagram of a topographic map display device according to the invention,

a FIG. 2 is a vertical terrain section illustrating the reference profile used for the splitting of the terrain strata represented on the topographic map displayed,

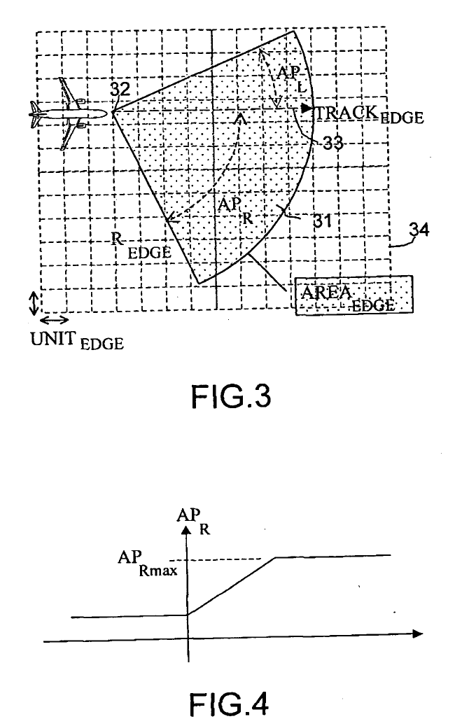

a FIG. 3 shows, on the map displayed, an emergency descent zone, superimposed on a tiling corresponding to the meshing of a topographic database from which the map displayed is extracted,

a FIG. 4 illustrates a law used for the definition of the opening of the angular sector of the emergency descent zone shown in FIG. 3,

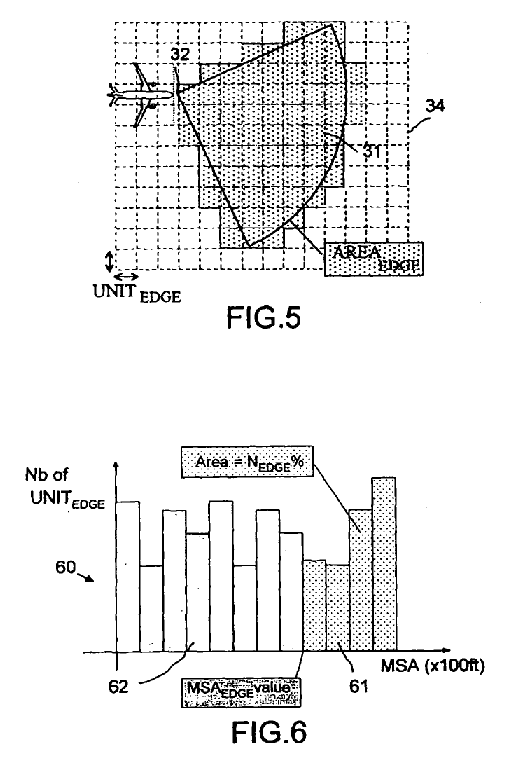

a FIG. 5 shows the elements of the tiling corresponding to the meshing of the topographic database from which the map displayed is extracted, which are covered, even partially, by the emergency descent zone shown in figure 3,

a FIG. 6 represents an exemplary distribution formed by minimum safety altitudes associated with the elements of the tiling of FIG. 5 and covered, even partially, by the emergency descent zone illustrated in FIGS. 3 and 5,

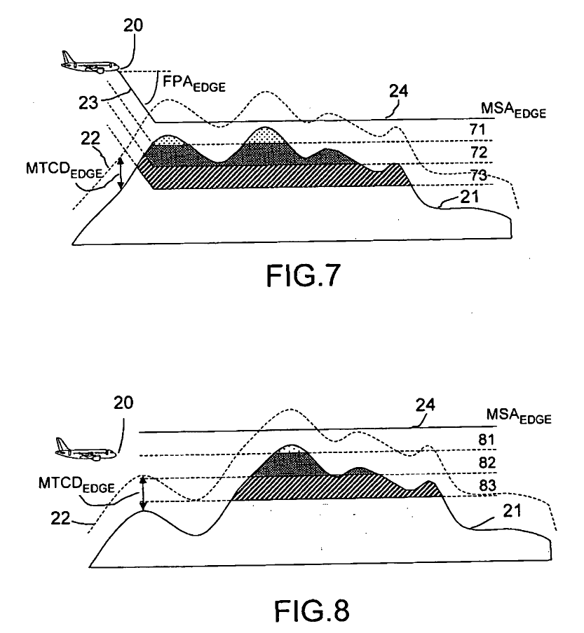

a FIG. 7 is a vertical terrain section showing the forms of the terrain strata represented on the map displayed in the case where the aircraft is at an altitude greater than the safety altitude, and

a FIG. 8 is a vertical terrain section showing the forms of the terrain strata represented on the map displayed in the cases where the aircraft is at an altitude of less than the reference altitude.

### DETAILED DESCRIPTION OF THE EMBODIMENTS

The topographic map display device 1 for aircraft, which is shown in FIG. 1, is associated with the navigation equipment 2 of the aircraft, with a topographic database 3 carried onboard the aircraft or accessible from the latter by radio communication, and with a ground proximity warner 4 of TAWS type.

The navigation equipment 2 provides current position and current altitude to the topographic map display device 1 and to the ground proximity warning system 4. The topographic database 3 covers, with a mesh of measurement points, the domain of deployment of the aircraft which is a more or less extensive part of the terrestrial surface and provides the topographic map display device 1 and the ground proximity warner TAWS 4 with the topographic elements allowing one of them, the topographic map display device 1, to formulate a map of the relief of the region overflown and the other one, the ground proximity warning system TAWS 4, to formulate a map of the region overflown pinpointing the reliefs and obstacles on the ground engendering a risk of collision. The ground proximity warning system TAWS 4 delivers, to the topographic map display device 1, visual alarm and alert maps pinpointing on a map of the region overflown, the threatening reliefs or obstacles on the ground, with a view to displaying them superimposed on the relief map formulated by the topographic map display device 1.

The topographic map display device 1 can be broken down into five parts fulfilling distinct functions: a part 11 for selecting the region displayed, a part 12 for calculating the safety altitude, a part 13 for choosing the terrain strata of the stack whose projection on the horizontal will serve to display the relief of the region selected and for allocating the colors and patterns to the terrain strata chosen, a part 14 for superimposing a possible visual alert and alarm map stemming from a ground proximity warning system 4 and finally a display screen 16.

The first part 11 of the display device providing for the selection of the region displayed, uses the current position of the aircraft as provided by the navigation equipment 2 and a representation scale setpoint originating from the pilot for locating the region overflown and determining the size and the orientation of the map to be displayed. In possession of these parameters, it extracts from the topographic database 3 the elements belonging to the surface of the map to be displayed which are, in fact:
altitudes measured in line with the mesh nodes addressed by their latitudes and their longitudes and bounded above by a safety margin MTCD (the acronym being derived from the expression “Minimum Terrain Clearance Distance”) taking account of various uncertainties including that associated with the altitude measurements themselves, and
minimum local altitudes imposed in line with these nodes when such altitudes exist.

The second part 12 provides for the calculation of a safety altitude on the basis of the minimum local altitudes imposed or deduced from the performance of the aircraft at the locations of the nodes of the mesh of the topographic database 3 belonging to a limited zone of the map displayed corresponding to the most probable overfly surface should the aircraft enter an emergency descent. The way of delimiting the emergency descent zone as well as the calculation of a safety altitude once the emergency descent zone has been delimited will be explained hereinafter.

The third part 13 distributes, based on the altitude values, the elements of the topographic database 3 belonging to the surface of the map to be displayed, into various strata which are referenced with respect to the safety altitude calculated by the second part 11 and whose profiles depend on the current altitude of the aircraft as provided by its navigation equipment 2. At the same time, it associates with the distributed elements, colors and/or textures representative of the stratum to which they belong.

The fourth part 14 superimposes on the map image elements provided by the third part 13, those of a possible visual alert and alarm map provided by the ground proximity alert system TAWS 4 so as to depict by priority on the screen 15 the threatening reliefs and obstacles on the ground, the map image elements provided by the third part 13 serving as background for the image displayed on the screen 15 and appearing only outside of these threatening reliefs and obstacles on the ground.

The display screen 15 gathers into a complete image forming a map of the relief of the region overflown mentioning the threatening reliefs and obstacles on the ground, the image elements reaching it from the fourth part 14 and displays this complete image for the attention of the crew of the aircraft.

FIG. 2 shows a vertical section 21 through the relief, effected in front of the current position 20 of the aircraft along its course. Also distinguished therein are the envelope 22 of this profile resulting from the allowance for the safety margin MTCD_{EDGE} and the form of the section profile model adopted for the terrain strata used in horizontal projection to construct the 2D map displayed by the topological map display device 1, when the aircraft is at an altitude greater than the safety altitude MSA (the acronym deriving from the expression: “Minimum Safety Altitude”). This profile model is defined in time with respect to the current position of the aircraft. It has a broken-line form with a first straight line segment 23 with negative slope angle FPA_{EDGE} going from the current position 20 of the aircraft up to the level of the safety altitude MSA where it is extended by a second horizontal straight line segment 24.

The negative slope angle FPA_{EDGE} of the first straight line segment 23 of the section profile model has the most constraining value for a rapid loss of altitude from among:
a setpoint value fixed by the constructor of the aircraft or by the airline which operates it as a function of the theoretical performance of the aircraft, such as for example its flight aptitude,
an instantaneous value calculated with the help of a database of the descent performance of the aircraft allowing for all or some of the following parameters: air speed, extended or retracted configuration of the landing gear and of the flaps, altitude, static and dynamic pressures, static temperature, weight of the aircraft, local wind,
the instantaneous value of the slope angle FPA of the aircraft's trajectory deduced from its ground speeds and vertical speed.

The descending part of the section profile model makes it possible to hide the reliefs that cannot become dangerous in the case of an emergency descent since the aircraft has already passed them.

The safety altitude MSA giving the level of the second horizontal straight line segment 24 of the profile model is calculated, as will be seen later, on the basis of minimum safety altitudes determined at the locations of the measurement points of the topographic database belonging to a zone of the map displayed corresponding to the most probable emergency descent trajectories from the current position of the aircraft and having regard to its course. It is always greater than the summit of the vertical profile 21 of the terrain overflown in the medium term but here and there may be less than the vertical safety margin MTCD_{EDGE} 22 taken vis-à-vis the altitude values extracted from the topological database.

The minimum safety altitudes determined at the locations of the measurement points of the database are minimum altitudes to be adhered to outside of take-off or landing, which comply with the definition of paragraph Sec. 91.119 of the general regulations applied to civil aviation, by the FAA (“Federal Aviation Agency”), in the United States. They correspond either to values imposed 1000 feet above the highest obstacle on the ground in a radius of 2000 feet when the zone overflown is densely inhabited, 500 feet above the other zones and at a minimum distance of 500 feet from a person, from a vehicle, from a ship or from a construction, or, more generally, at a value sufficient to be able to undertake a makeshift landing outside of an inhabited zone should there be an engine problem. In the latter case, they are obtained on the basis of standard calculations taking into consideration the glide capabilities of the aircraft and the regulatory limit values when they are applicable. They are stored in the topological database 3 in the same guise as the altitude.

FIG. 3 represents the zone 31 used for the calculation of the safety altitude serving as absolute reference for the terrain strata displayed by the topographic map display device 1. This zone 31 is delimited in such a way as to correspond to the zone of largest probability of presence of the aircraft during an emergency descent from its current position 32. It has the form of an angular sector of radius R_{EDGE}, starting from the current position 32 of the aircraft, and opening out around the direction 33 of the course (or track) followed by the aircraft.

The radius R_{EDGE} of the angular sector of this emergency descent zone 31 is chosen as a function of the anticipation time T_{EDGE} proposed to the crew, for example, ten minutes, and of the ground speed GS of the aircraft by implementing the relation:
R_{EDGE}=GS×T_{EDGE}

The angles of opening AP_{L} and AP_{R} of the angular sector of this emergency descent zone 31 are dependent on the instantaneous rate of rotation θ_{EDGE} of the aircraft, according to the linear law shown in FIG. 4.

The case of FIG. 3 corresponds to an aircraft impressed with a rate of rotation to the right.

The background tiling 34 resulting from the meshing of the region overflown, by the topographic database 3 exhibits rectangular elementary tiles of unitary dimensions in abscissa and ordinate expressed in arc-seconds of latitude and of longitude, for example 360″. To each elementary tile there corresponds a measurement point with which are associated, in the topographic database 3, a measured altitude and a minimum safety altitude.

FIG. 5 borrows the same elements as FIG. 3 while emphasizing the elements of the tiling resulting from the meshing of the cartographic database, which are covered in full or in part by the emergency descent zone 31. These elements correspond to the measurement points of the topographic database 3 whose minimum safety altitudes are employed for the determination of the safety altitude MSA_{EDGE} serving as reference for the terrain strata displayed. The safety altitude MSA_{EDGE} is the minimum safety altitude value which is exceeded only by a given percentage N_{EDGE} % of the minimum safety altitudes adopted. As shown in FIG. 6, this value may be determined by clipping the upper values of a distribution array 60 enumerating the frequency of one and the same value of minimum safety altitude as a function of its amplitude. In FIG. 6, the area 61 of the distribution corresponding to the percentage N_{EDGE} % appears on the right heavily hatched. The value adopted for the safety altitude MSA_{EDGE} is the value corresponding to the upper limit of the zone 62 of the distribution array remaining after clipping and represented lightly hatched.

FIG. 7 gives an exemplary stack of terrain strata that is used in horizontal projection for display on the screen 15 of the topographic map display device 1 when the aircraft 20 is at an altitude greater than the safety altitude MSA_{EDGE}. The terrain strata 71, 72, 73 are defined in relation to the reference profile which has been described in relation to FIG. 2 and which includes a descending part 23 and a long plateau 24.

These terrain strata are advantageously represented by a gradation of green colors corresponding to an absence of risk in the scale of risks adopted on the visual alert and alarm maps of the ground proximity warning systems of TAWS type.

FIG. 8 gives an exemplary stack of terrain strata that is used in horizontal projection for display on the screen 15 of the topographic map display device 1 when the aircraft 20 is at an altitude below the safety altitude MSA_{EDGE}. The terrain strata 81, 82, 83 are defined in relation to the horizontal reference profile. In the case where a ground proximity warning system of TAWS type is present and delivers visual alarm and alert maps, the terrain strata may be represented, as in the previous figure, by a gradation of green colors corresponding to an absence of risk in the scale of risks adopted on the visual alert and alarm maps of the ground proximity warning systems of TAWS type since they will be hidden in case of risk of collision with the ground by the threatening reliefs and obstacles on the ground appearing in a red color synonymous with immediate danger or yellow color synonymous with medium-term danger. In the absence or in case of non-operation of a ground proximity warning system, it is preferable to adopt the red color for the terrain strata of levels greater than the current altitude of the aircraft and the yellow color for the terrain strata of levels close to the current altitude of the aircraft so as to attract the attention of the crew of the aircraft to them.

1. A device for 2D topographic map display for aircraft, extracting from a topographic database a map formed from the projection on the horizontal of a stack of terrain strata of the region overflown, corresponding to terrain sections with mainly horizontal profile, wherein the terrain sections with mainly horizontal profile are referenced with respect to an absolute altitude that is greater than that of the highest surrounding relief, which absolute altitude is termed the safety altitude MSA_{EDGE} (24).

2. The device as claimed in claim 1, wherein when the topographic map is extracted from a topographic database storing the altitudes of a mesh of points of a zone of the terrestrial surface enclosing the region overflown, the safety altitude MSA_{EDGE} is deduced from the minimum local safety altitudes assigned to the points of the mesh of the topographic database.

3. The device as claimed in claim 2, wherein the safety altitude MSA_{EDGE} is deduced from the minimum local safety altitudes assigned to the points of the mesh of the topographic database belonging, in the region overflown, to a so-called emergency descent zone, related to the current position of the aircraft and containing probable trajectories predicted for an aircraft following a maximum imposed descent slope FPA_{EDGE}.

4. The device as claimed in claim 3, wherein the value of the safety altitude MSA_{EDGE} is extracted from the distribution, as a function of their values, of the minimum local safety altitudes assigned to the points of the mesh of the topographic database belonging, in the region overflown, to the emergency descent zone and corresponds to the maximum value MAS_{EDGE}value of the minimum local safety altitudes appearing in this distribution after clipping of a certain percentage N_{EDGE} % of the largest values of minimum local altitudes that it contains.

5. The device as claimed in claim 1, wherein the terrain strata represented (81, 82, 83) correspond to terrain sections along horizontal profiles.

6. The device as claimed in claim 1, wherein when the aircraft is at an altitude greater than the safety altitude MSA_{EDGE} with respect to which the terrain strata represented are referenced, the terrain strata represented correspond to terrain sections along mainly horizontal elbowed profiles reducing, by vertical translation, to a broken line starting with a first straight line segment with negative slope going from the current position of the aircraft up to the level of the safety altitude MSA_{EDGE} and continuing as a second horizontal straight line segment.

7. The device as claimed in claim 6, wherein the negative slope angle of the first straight line segment is taken equal to the most negative slope angle FPA_{EDGE} from among the angle of the current slope followed by the aircraft, the maximum descent slope angle permitted for the aircraft and the arc tangent of the ratio between the ground speed of the aircraft and a maximum descent speed permitted for the aircraft.

8. The device as claimed in claim 1, wherein when the aircraft is below the safety altitude MSA_{EDGE} with respect to which the terrain strata represented are referenced, the terrain strata represented correspond to horizontal sections.

9. The device as claimed in claim 1, wherein the colors and/or textures associated with the levels of terrain strata in a map displayed correspond to the same risk scale as that associated with the colors and/or textures of a visual alarm map originating from a ground proximity warning system.

10. The device as claimed in claim 1, wherein the colors associated with the terrain strata represented, situated below the altitude of the aircraft (71, 72, 73), belong to the green interval.

11. The device as claimed in claim 1, wherein the colors associated with the terrain strata represented, situated at levels close to the current altitude of the aircraft, belong to the yellow interval.

12. The device as claimed in claim 1, wherein the color associated with the terrain strata represented, situated above the altitude of the aircraft is red.

13. The device as claimed in claim 1, wherein, when the aircraft is equipped with a ground proximity warning system producing visual alarm maps pinpointing threatening reliefs or obstacles on the ground, the colors and/or textures associated with the levels of terrain strata represented in a relief map displayed by said device comply with the same risk scale as those of the visual alarm maps and in that it comprises a superposition circuit superimposing the visual alarm maps on the map of the relief which appears as background around threatening reliefs and obstacles on the ground.

14. The device as claimed in claim 1, wherein when the aircraft is equipped with a ground proximity warning system producing visual alert and alarm maps pinpointing threatening reliefs and obstacles on the ground and distinguishing them by different colors and/or textures as a function of the short- or medium-term character of the threat that they pose, the color and/or texture associated, in an alarm and alert map, with a relief or obstacle on the ground giving rise to a short-term threat are borrowed for a terrain stratum level represented situated at an altitude greater than that of the aircraft and the color and/or the texture associated with a relief or an obstacle on the ground giving rise to a medium-term threat are borrowed for a terrain stratum level represented situated at the altitude of the aircraft.
